(19) United States
(12) Patent Application Publication
(10) Pub. No.: US 2006/0146443 A1
(43) Pub. Date: Jul. 6, 2006

(54) Method and apparatus for airflow transition edges on noise dampers in a hard disk drive

(76) Inventors: Joseph Chang, San Jose, CA (US); Gregory Tran, Santa Clara, CA (US); Yun-Sik Han, Santa Clara, CA (US); Frank Morris, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/028,078

(22) Filed: Dec. 30, 2004

(51) Int. Cl. G11B 33/14

(52) U.S. Cl. 360/97.02

(57) ABSTRACT

The present invention includes apparatus and methods for disk dampers with an inlet edge and/or an outlet edge, oriented and shaped to control airflow within the hard disk drive. The inlet edge and the outlet edge reduce the airflow turbulence at the actuator assembly. This improves the Position Error Signal (PES), as the read-write head accesses a rotating disk surface. The outlet edge may preferably be curved and oriented at an oblique angle with respect to the angular rotation of the disk(s) in the hard disk drive. The outlet edge may preferably extend over a section of a sector angle. The inlet edge may preferably be oblique, which helps to slow down the overall velocity of the airflow into the disk damper. This allows the tip of the inlet edge to be positioned closer to the actuator assembly than previously possible.

### TECHNICAL FIELD

The invention relates to noise dampening structures in a hard disk drive. More particularly, the invention relates to a disk damper configured to reduce air turbulence, which otherwise causes vibrations causing the read-write head to experience noise when accessing the rotating disk surface.

### BACKGROUND OF THE INVENTION

Disk dampers suppress system noise caused by the vibration of the rotating disk or disks. The gaseous media (often air) surrounding the rotating disks is moved by the rotating disk surfaces. The airflow circulating between the disks and disk damper forms a flat, thin donut-shaped channel. This channel often has a rectangular cross section that extends from the outside diameter to the inside diameter of the rotating disk surfaces. If the spacing between the disk and the disk damper is small enough, and the overlap between them is large enough, the thin air film in the channel has the desired damping effect.

While the prior art disk dampers reduce noise from the vibration of the disk(s), there remain problems. For example, some prior art disk dampers while reducing disk vibrations, add a different type of noise. The air stream, after leaving the channel, creates turbulence, which interacts with the actuator assembly. This interaction increases the noise experienced by the read-write head in the actuator assembly as it accesses the rotating disk surface. The turbulence is caused by the physical configuration of the disk damper. Specifically, the typical prior art disk damper has blunt edges. As the airflow leaves the channel, the blunt edges create rapid air expansion and pressure changes, which lead to turbulence. What is needed is a disk damper reducing the air turbulence, which vibrates the actuator assembly, causing the read-write head to experience noise when accessing the rotating disk surface.

### SUMMARY OF THE INVENTION

The present invention includes apparatus and methods for disk dampers configured to reduce air turbulence. Disk dampers fabricated in accord with the invention include an inlet edge and/or an outlet edge, oriented and shaped to control airflow within the hard disk drive to minimize the airflow turbulence experienced by the actuator assembly. Reducing the turbulence experienced by the actuator assembly improves the Position Error Signal (PES), as the read-write head accesses a rotating disk surface. As used herein, the inlet edge refers to the leading edge as the airflow enters the channel. The outlet edge refers to the trailing edge as the airflow leaves the channel. The invention applies to hard disk drives including air or other gasses within their enclosure.

The outlet edge is preferably be curved and oriented at an oblique angle with respect to the angular rotation of the disk(s) in the hard disk drive. The outlet edge preferably extends over a section of a sector angle. The distributed airflow along the outlet edge permits the overall flow velocity to slow gradually, which creates less turbulence near the actuator assembly and consequently less system noise. As used herein, an oblique angle is not a blunt angle, which approaches being a right angle.

The inlet edge is preferably oblique, which helps to slow the overall velocity of the airflow into the disk damper. This also allows the tip of the inlet edge to be positioned closer to the actuator assembly than previously possible, which reduces air velocity at the actuator assembly, additionally minimizing the noise caused by air turbulence.

Embodiments of the invention including both oblique outlet edges and oblique inlet edges have been experimentally shown to improve the PES for the rotating disk surfaces.

### BRIEF DESCRIPTION OF THE DRAWINGS

FIG. 1 shows a top view of a hard disk drive including a disk damper according to the present invention;

FIG. 2 shows a hard disk drive including an alternate embodiment of the disk damper shown in FIG. 1; and

FIG. 3 shows a perspective view of a hard disk drive including multiple disk dampers as shown in FIG. 1.

### DETAILED DESCRIPTION

The present invention includes apparatus and methods for disk dampers with an inlet edge and/or an outlet edge, oriented and shaped to control airflow within the hard disk drive to minimize the airflow turbulence experienced by actuator assembly. The invention improves the Position Error Signal (PES), as the read-write head accesses a rotating disk surface. As used herein, the inlet edge refers to the leading edge as the airflow enters the channel. The outlet edge refers to the trailing edge as the airflow leaves the channel. The invention is particularly suited for use in hard disk drives including air or other gasses within the disk drive enclosure.

Currently, the gap between a disk surface and the facing, prior art, disk damper surface is about 0.5 millimeter (mm). This gap generates a thin pressurized air film, used to suppress disk vibrations. In typical current disk drives there is a blunt angular transition of the airflow cross section at the outlet edge. This blunt angular transition causes the sudden release, expansion and depressurizing of the air film as it leaves the channel, which can create excessive air turbulence as it moves away from such outlet transitions.

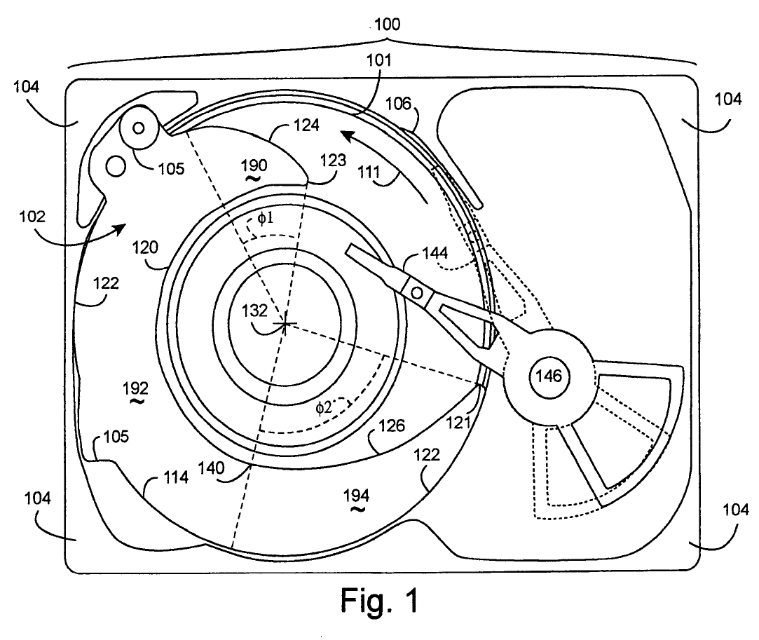

FIG. 1 shows a disk damper 102 including an inlet edge 124 and an outlet edge 126 used to control the circulating airflow 111 within a hard disk drive 100. The inlet edge 124 and the outlet edge 126 minimize the airflow turbulence experienced by the actuator assembly 144, which improves the quality measure known as the Position Error Signal (PES). The actuator assembly 144 includes at least one read-write head for accessing data on a rotating disk surface 109. The hard disk drive 100 includes a gaseous media within the enclosure 104. The gaseous media is preferably air, but may also include other gases.

The disk damper preferably includes three contiguous, coplanar sections, an inlet transition section 190, and an intermediate section 192, and an outlet transition section 194. The intermediate section 192 preferably has an essentially constant radial width (the radial line originates from the spindle Z-axis 132), and has a length extending between φ1 and φ2. Both the inlet transition section 190 and the outlet transition section 194 have varying radial widths. The radial width of inlet transition section 190 increases through the length of φ1 from zero to the radial width of the intermediate section, and the radial width of the outlet transition section 194 increases through the length of φ2 from zero to the radial width of the intermediate section.

The disk damper 102 is spaced apart form the disk surface 109 to form a gap or channel between them. The channel is best seen in FIG. 4 and is indicated by the number 133. Referring again to FIG. 1, the gaseous media moves in the air flow channel 133 between the disk surface 109 and the disk damper 102. The channel 133 extends partway around the spindle Z-axis 132

In the embodiment shown in FIG. 1, the inlet edge 124 is a segment of a circle, which shape has been found to reduce turbulence near the actuator assembly 144 and resulting system noise. However, in alternate embodiments, other continuous contours may be useable for the inlet edge 124 with desirable results. Similarly, the outlet edge 126 is also a segment of a circle, which shape has been found to reduce turbulence near the actuator assembly 144 and resulting system noise. Again, in alternate embodiments, other continuous contours may be useable for the outlet edge 126 with desirable results.

The outlet edge 126 is preferably curved and oriented at an oblique angle to the angular rotation of at least disk 101, with the curve extending over an arc of a φ2 angle. The distributed airflow along the oblique outlet edge 126 permits the overall flow velocity to slow gradually, which creates less turbulence near the actuator assembly 144 and consequently less system noise. Outlet end 121 and the outlet edge 126 are joined smoothly.

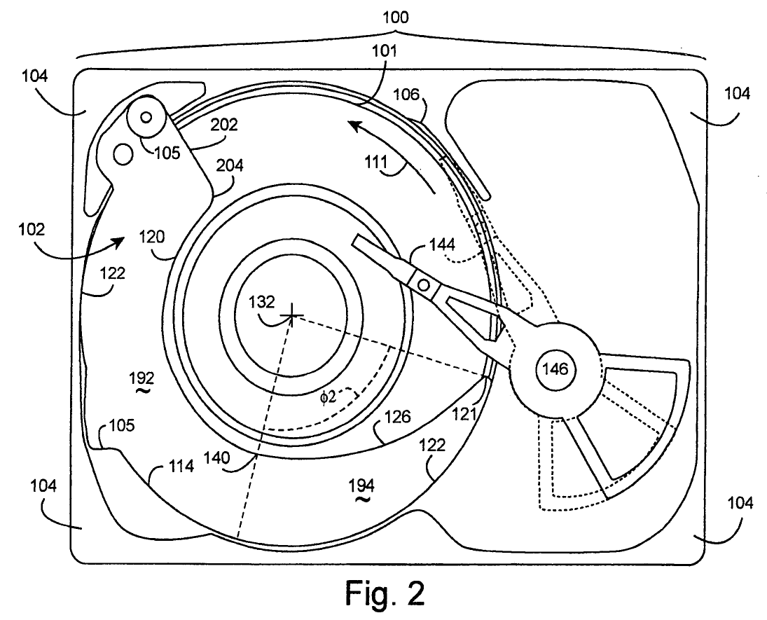

An alternate embodiment is seen in FIG. 2, in which the disk damper 102 includes the outlet edge 126 configured as discussed above to reduce turbulence, but an includes an abrupt radial inlet edge 202. The configuration of the outlet edge 126 may be more important than the configuration of the inlet edge 202 for reducing turbulence.

The φ2 angle is preferably between twenty degrees and eighty degrees, but more preferrably between twenty five degrees and seventy degrees, and still more preferrably between thirty degrees and sixty degrees.

The inlet edge 124 is preferably curved and oriented at an oblique angle to the angular rotation of the disk 101, with the curve extending over an arc of a φ1 angle. This configuration has been found to slow the velocity of the gaseous media in the channel 133 and reduce turbulence created at the inlet edge. Consequently, the tip 123 of the inlet edge 124 may be closer to the actuator assembly 144 than is possible in prior art designs.

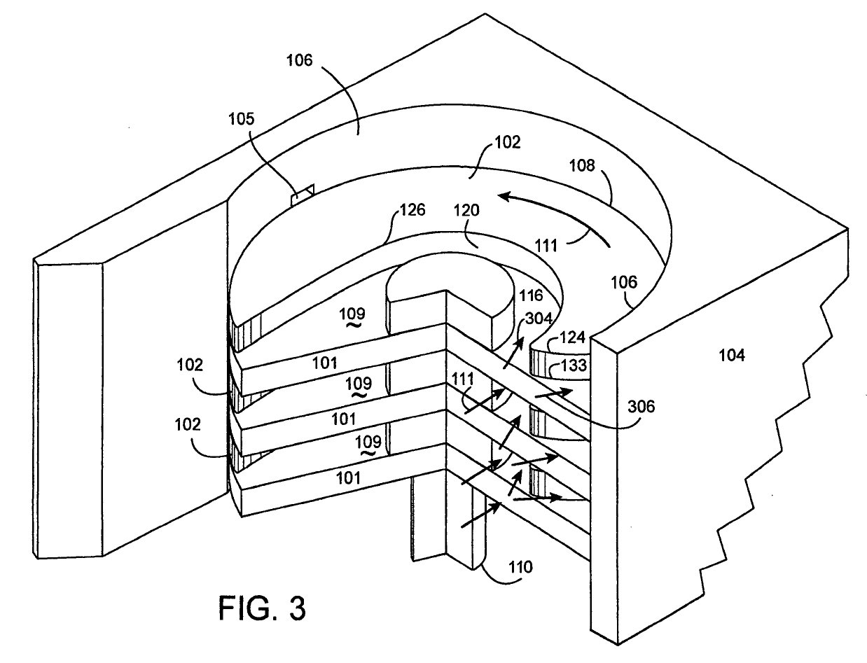

The inlet edge 124 receives a circulating airflow 111 from the direction of the actuator assembly 144. Referring to FIG. 3, the circulating airflow 111 is divided by the inlet edge 124 into an inner channel airflow 304 and an outer channel airflow 306. The inner channel airflow 304 tends to avoid the channel 133. A portion of the outer channel airflow 306 deflects away from the inlet edge 124. Another portion of the outer channel airflow 306 crosses the inlet edge 124 to create the airflow through the channel 133. This portion of circulating airflow 111 is received gradually across the inlet edge 124, instead of arriving suddenly, as it does in prior art design. Because there is less pressure upon crossing the inlet edge 124, the velocity of the gaseous media within the channel 133 is reduced.

The φ1 angle is preferably between twenty degrees and sixty degrees, but more preferrably between twenty five degrees and fifty degrees, and still more preferrably between thirty degrees and forty five degrees.

This invention is particularly suited for use in a hard disk including more than one disk. FIG. 3 shows a partial cutaway perspective view of the hard disk drive 100 with multiple instances of the disk damper 102 of FIG. 1. The hard disk drive 100 includes more than one disk 101 and more than one disk damper 102.

Tables 1, 2 and 3 show comparisons of three PES measurements taken at three different radial locations on hard disk drives assembled with two different disk damper assemblies: (1) A disk damper constructed in accord with the invention, and (2) a prior art disk damper. The Tables show noticeable improvement by lowering the noise spectrum for the hard disk drive with the disk damper invention. The Middle Diameter refers to measurements performed midway between the Inside Diameter 150 and the Outside Diameter 108 on the rotating disk surface 109 of the Figures.

TABLE 1
Average Non-Repeatable Run-Out (NRRO)
spectrum energy in terms of PES.

| | Outside | Middle | Inside |
|---|---|---|---|
| Hard Disk Drive using: | Diameter | Diameter | Diameter |
| Invention disk damper | 9.30 | 6.63 | 5.49 |
| Prior art disk damper | 9.82 | 8.02 | 6.32 |

TABLE 2
Average total spectrum energy in terms of PES.

| | Outside | Middle | Inside |
|---|---|---|---|
| Hard Disk Drive using: | Diameter | Diameter | Diameter |
| Invention disk damper | 12.12 | 9.44 | 8.18 |
| Prior art disk damper | 13.22 | 10.90 | 9.72 |

TABLE 3
Average Repeatable Run-Out (RRO)
spectrum energy in terms of PES

| | Outside | Middle | Inside |
|---|---|---|---|
| Hard Disk Drive using: | Diameter | Diameter | Diameter |
| Invention disk damper | 7.60 | 6.69 | 6.04 |
| Prior art disk damper | 8.81 | 7.36 | 7.36 |

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. An apparatus for a disk damper in a hard disk drive, comprising:
an outlet edge providing a first oblique angle from an outside diameter of a neighboring rotating disk surface, said outlet edge distributing the flow of a gaseous media from a channel to reduce turbulence at an actuator assembly in said hard disk drive, said channel formed between said disk damper and said neighboring rotating disk surface in said hard disk drive;
an inlet edge providing a second oblique angle from an inside diameter of said neighboring rotating disk surface, said inlet edge reducing the flow of said gaseous media into said the flow of a channel moved by said neighboring rotating disk surface to reduce turbulence at said actuator assembly.

2. The apparatus of claim 1, wherein said outlet edge provides said first oblique angle from said inside diameter to said outside diameter of said neighboring rotating disk surface across a Phi2 angle; and
wherein said inlet edge provides said second oblique angle increasing from said inside diameter to said outside diameter of said neighboring rotating disk surface across a Phi1 angle.

3. The apparatus of claim 2, wherein said Phi1 angle is between twenty degrees and sixty degrees; and wherein said Phi12 angle is between twenty degrees and eighty degrees.

4. The apparatus of claim 3, wherein said Phi1 angle is between twenty five degrees and fifty degrees; and wherein said φ2 angle is between twenty five degrees and seventy degrees.

5. The apparatus of claim 4, wherein said Phi1 angle is between thirty degrees and forty five degrees; and wherein said Phi12 angle is between thirty degrees and sixty degrees.

6. The hard disk drive of claim 1, comprising said disk damper positioned near said neighboring rotating disk surface to facilitate the flow of said gaseous media from said channel and moved by said neighboring rotating disk surface to reduce turbulence at an actuator assembly in said hard disk drive.

7. A method making said hard disk drive of claim 1, comprising the step of
positioning said disk damper near said neighboring rotating disk surface to facilitate the flow of said gaseous media from said channel and moved by said neighboring rotating disk surface to reduce turbulence at an actuator assembly in said hard disk drive.

8. The hard disk drive as the product of the process of claim 6.

9. An apparatus for a disk damper in a hard disk drive, comprising:
an outlet edge providing a first oblique angle from an outside diameter of a neighboring rotating disk surface; said outlet edge distributing the flow of a gaseous media from a channel to reduce turbulence at an actuator assembly in said hard disk drive, said flow of said gaseous media from said channel is formed between said disk damper and said neighboring rotating disk surface in said hard disk drive.

10. The apparatus of claim 9, further comprising:
an inlet edge providing a second oblique angle from said inside diameter of said neighboring rotating disk surface; said inlet edge reducing the flow of said gaseous media into said channel moved by said neighboring rotating disk surface to reduce turbulence at said actuator assembly.

11. The apparatus of claim 10, wherein said inlet edge provides said second oblique angle increasing from said inside diameter to said outside diameter of said neighboring rotating disk surface across a Phi1 angle.

12. The apparatus of claim 11, wherein said Phi1 angle is between twenty degrees and sixty degrees.

13. The apparatus of claim 12, wherein said Phi1 angle is between twenty five degrees and fifty degrees.

14. The apparatus of claim 13, wherein said Phi1 angle is between thirty degrees and forty five degrees.

15. The apparatus of claim 9, wherein said outlet edge provides said first oblique angle increasing from said inside diameter to said outside diameter across a Phi2 angle.

16. The apparatus of claim 15, wherein said Phi2 angle is between twenty degrees and ninety degrees.

17. The apparatus of claim 16, wherein said Phi2 angle is between twenty five degrees and seventy degrees.

18. The apparatus of claim 17, wherein said Phi2 angle is between thirty degrees and sixty degrees.

19. The hard disk drive of claim 9, comprising said disk damper positioned near said neighboring rotating disk surface to facilitate the flow of said gaseous media from said channel and moved by said neighboring rotating disk surface to reduce turbulence at an actuator assembly in said hard disk drive.

20. A method making said hard disk drive of claim 9, comprising the step of
positioning said disk damper near said neighboring rotating disk surface to facilitate the flow of said gaseous media from said channel and moved by said neighboring rotating disk surface to reduce turbulence at an actuator assembly in said hard disk drive.

21. The hard disk drive of as the product of the process of claim 20.

22. An apparatus for a disk damper in a hard disk drive, comprising:
an inlet edge providing a second oblique angle from an inside diameter of a neighboring rotating disk surface; said inlet edge reducing the flow of a gaseous media into a channel moved by said neighboring rotating disk surface to reduce turbulence at said actuator assembly.

23. The apparatus of claim 22, further comprising:
an outlet edge providing a first oblique angle from an outside diameter of a neighboring rotating disk surface; said outlet edge distributing the flow of a gaseous media from said channel to reduce turbulence at an actuator assembly in said hard disk drive, said the flow of said channel is formed between said disk damper and said neighboring rotating disk surface in said hard disk drive.

24. The apparatus of claim 23, wherein said outlet edge provides said first oblique angle increasing from said inside diameter to said outside diameter across a Phi2 angle.

25. The apparatus of claim 24, wherein said Phi2 angle is between twenty degrees and ninety degrees.

26. The apparatus of claim 25, wherein said Phi2 angle is between twenty five degrees and seventy degrees.

27. The apparatus of claim 26, wherein said Phi2 angle is between thirty degrees and sixty degrees.

28. The apparatus of claim 22, wherein said inlet edge provides said second oblique angle from said inside diameter to said outside diameter across a Phi1 angle.

29. The apparatus of claim 28, wherein said Phi1 angle is between twenty degrees and sixty degrees.

30. The apparatus of claim 29, wherein said Phi1 angle is between twenty five degrees and fifty degrees.

31. The apparatus of claim 30, wherein said Phi1 angle is between thirty degrees and forty five degrees.

32. The hard disk drive of claim 22, comprising said disk damper positioned near said neighboring rotating disk surface to facilitate the flow of said gaseous media from said channel and moved by said neighboring rotating disk surface to reduce turbulence at an actuator assembly in said hard disk drive.

33. A method making said hard disk drive of claim 22, comprising the step of
positioning said disk damper near said neighboring rotating disk surface to facilitate the flow of said gaseous media from said channel and moved by said neighboring rotating disk surface to reduce turbulence at an actuator assembly in said hard disk drive.

34. The hard disk drive of as the product of the process of claim 33.
